(19) United States
(12) Patent Application Publication
(10) Pub. No.: US 2005/0289079 A1
(43) Pub. Date: Dec. 29, 2005

(54) Systems and methods for biometric identification

(75) Inventors: Baldev Krishan, Fremont, CA (US); Gurminder Singh, Cupertino, CA (US); Nasir Karamat, Santa Clarita, CA (US)

Correspondence Address: FISH & NEAVE IP GROUP;ROPES & GRAY LLP, 1251 AVENUE OF THE AMERICAS FL C3, NEW YORK, NY, 10020-1105, US

(73) Assignee: SHIMON SYSTEMS, INC.

(21) Appl. No.: 10/847,844

(22) Filed: May 17, 2004

(51) Int. Cl. G06Q 99/00

(52) U.S. Cl. 705/64

(57) ABSTRACT

Apparatus and methods for registering biometric information may include receiving the biometric information from an individual; receiving identification information from the individual; and certifying that the identification information identifies the individual. Apparatus and methods for verifying the identity of a participant in an electronic transaction may include receiving over an electronic communication network first physical biometric information derived from the participant; and comparing the first biometric information to second biometric information.

### BACKGROUND OF THE INVENTION

This invention relates to securing electronic transactions and, more particularly, to verifying an identity of a participant in such a transaction. Commonly, one participant in a transaction may verify the identity of another participant in the transaction by requesting that the participant provide information such as a name, an address, a date of birth, a mother's name, a social security number, and a digital certificate. In some transactions, a non-participant third party may be involved to verify the identity. If a non-participant third party verifies the identity, the third-party may verify the identity by requesting the same information. The information is easily stolen and may be used to conduct fraudulent transactions that may be injurious to others.

It would therefore be desirable to provide improved apparatus and methods for verifying an identity of a participant in an electronic transaction.

### SUMMARY OF THE INVENTION

It is an object of this invention to provide improved apparatus and methods for verifying an identity of a participant in an electronic transaction.

In accordance with the principles of the invention, systems and methods for registering biometric information in an identity information management apparatus are provided. The systems and methods may involve receiving the biometric information from an individual; receiving identification information from the individual; and certifying that the identification information identifies the individual.

In accordance with the principles of the invention, systems and methods for verifying the identity of a participant in an electronic transaction are provided. The systems and methods may involve receiving over an electronic communication network first physical biometric information derived from the participant; and comparing the first physical biometric information to second biometric information.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 is an illustrative schematic diagram of apparatus in accordance with the principles of the invention;

FIG. 2 is another illustrative schematic diagram of apparatus in accordance with the principles of the invention;

FIG. 3 is an illustrative detailed schematic diagram of a portion of the apparatus shown in FIGS. 1 and 2;

FIG. 4 is another illustrative detailed schematic diagram of a portion of the apparatus shown in FIGS. 1 and 2;

FIG. 5 is an illustrative diagram showing steps that may be included in a method in accordance with the principles of the invention;

FIG. 6 is an illustrative detailed diagram showing steps that may be involved in a step shown in FIG. 5;

FIG. 7 is an illustrative display in accordance with the principles of the invention;

FIG. 8 is another illustrative display in accordance with the principles of the invention;

FIG. 9 is yet another illustrative display in accordance with the principles of the invention;

FIG. 10 is another illustrative diagram showing steps that may be included in a method in accordance with the principles of the invention;

FIG. 11 is an illustrative example of information that may be used in accordance with the principles of the invention; and

FIG. 12 is still another illustrative display in accordance with the principles of the invention.

### DETAILED DESCRIPTION OF THE INVENTION

The invention may provide systems and methods for registering biometric information in an identify information management apparatus. A method in accordance with the principles of the invention may include receiving biometric information from an individual; receiving identification information from the individual; and certifying that the biometric information identifies the individual. In some embodiments of the invention, the method may include certifying that the identification information identifies the individual.

A system in accordance with the principles of the invention may include a sensor configured to receive biometric information from an individual and communicate the biometric information to the apparatus; and at least one access device. One or more access devices may be configured to receive identification information from the individual. One or more access devices may be configured to receive certifying information from a certifier. One or more access devices may be configured to communicate one or more of the identification information and the certifying information to the apparatus; and the certifying information may certify that the identification information identifies the individual. (As used herein, the terms “processor” and “apparatus” may refer to one or more physical devices that may be present at one or more physical locations.) Systems may be provided for performing steps of any of the methods or processes shown or described herein.

Identification information may include documentary information. Identification information may include personal information. For example, the identification information may include one or more of a name, an address, a date of birth, a mother's name, a social security number, a certificate, a digital certificate, a passport, a birth certificate, a license, a photograph, a notarized document, a credit card, an identification card, a diploma, a social security card, a legal instrument or any other suitable information, document or article.

In some embodiments of the invention, the certifying information may certify that the biometric information is from the individual. In some embodiments of the invention, the certifying information may certify that the identification information identifies the individual. In some embodiments of the invention, the certifying information may certify that the individual presented the identification information to a certifier. In some embodiments of the invention, the certifying information may certify that the biometric information was obtained from the individual. The biometric information may identify the participant. The identification information may identify the participant.

The biometric information may include a digitized template. The digitized template may include a minutia template. The digitized template may be in conformance with a standard. The standard may be a Common Biometric Exchange File Format (hereinafter, “CBEFF”) standard. The digitized template may include a finger print. The digitized template may include a voice print. The digitized template may include a face print. The face print may be an optical image of a human face. The digitized template may include an iris scan. The digitized template may include a retina scan. The digitized template may include a hand scan. The digitized template may include a signature scan. The digitized template may include a blood vessel scan. Receiving the biometric information may include prompting the individual to provide the biometric information.

In some embodiments of the invention, the sensor may be configured to receive a signal from a body portion of the individual. The signal may include an image. The signal may include light. The signal may include electrical charge. The signal may include sound., The signal may include pressure.

The body portion may include a portion of a finger. The body portion may include a portion of a hand. In some embodiments of the invention, the signal may be transmitted from the hand to the device via an instrument. The instrument may be a stylus. The instrument may be a writing instrument.

The body portion may include a portion of a mouth. The body portion may include a portion of an eye. The eye portion may include a portion of an iris. The eye portion may include a portion of a retina. The body portion may include a portion of a face. The body portion may include a portion of a blood vessel. The blood vessel may be a vein. The blood vessel may be an artery. The blood vessel may be a capillary.

In some embodiments of the invention, certifying may include confirming identification information. The confirming may include verifying an address. The confirming may include verifying a name. The confirming may include verifying a date of birth. The confirming may include verifying an identification number. The identification number may be a social security number. The confirming may include verifying license information. The license information may include automobile driver's license information.

Some embodiments of the invention may include providing a certifier. In those embodiments, receiving biometric information may include receiving the biometric information from the individual in the presence of the certifier. In those embodiments, receiving identification information may include receiving the identification information from the individual in the presence of the certifier.

The certifying may include verifying a certifier identity. Verifying the certifier identity may include receiving first certifier biometric information from the certifier and comparing the first certifier biometric information to second biometric information. The verifying may include providing a certificate to the certifier. The certificate may be a license. The license may be a notary public license. The certifying may include notarizing a document. The notarizing may include electronically notarizing the document. The document may be an electronic document.

The invention may provide systems and methods for verifying the identity of a participant in an electronic transaction. A method in accordance with the principles of the invention may include receiving over an electronic communication network first physical biometric information derived from the participant; and comparing the first physical biometric information to second biometric information. The method may include retrieving the second biometric information from a data storage device.

The transaction may be an e-commerce transaction. The transaction may be an e-business transaction. The transaction may involve a purchase of goods. The transaction may involve a purchase of services. The transaction may involve an acquisition of a financial instrument. The transaction may involve an acquisition of property. The transaction may involve a retrieval of information. The transaction may involve a submission of information. The transaction may involve a transfer of information. The transaction may involve a transfer of funds.

The transaction may involve processing stored information. The transaction may involve retrieving stored information. The transaction may involve storing information. The transaction may involve revising information. The transaction may involve uploading information. The transaction may involve downloading information. The transaction may involve printing information.

A system in accordance with the principles of the invention may include a processor configured to receive over an electronic communication network first physical biometric information received from the participant and compare the first biometric information to second biometric information; and a data storage device configured to provide the second biometric information to the processor.

As used herein, physical biometric information is behavior independent. Behavior-dependent biometric information may depend on the behavior of an individual from whom the biometric information is received. For example, an individual may create two different voice prints by producing different voice tones for the two different voice prints. Also, an individual may create two different signatures by using two different styles of writing. A voice print and a signature are, therefore, behavior-dependent. An individual may not produce different physical biometric information by using different behaviors.

The first physical biometric information may include a first digitized template, which may have one or more of the features described above in connection with a digitized template. The second biometric information may include a second digitized template, which may have one or more of the features described above in connection with a digitized template.

In some embodiments of the invention, the receiving may include receiving data in conformance with a format. The format may be a markup language format. The format may be in conformance with the Hyper Text Markup Language. The format may be in conformance with the Extensible Markup Language.

In some embodiments of the invention, the receiving may include transferring data in conformance with a file transfer protocol. The protocol may be the File Transfer Protocol. The protocol may include an electronic mail protocol. The mail protocol may include the Simple Mail Transfer Protocol. The protocol may include the Hyper Text Transfer Protocol.

In some embodiments of the invention, the receiving may include prompting the participant to provide the first biometric information.

Some embodiments of the invention may include providing a device configured to receive a signal from a body portion of the participant. The signal may include an image. The signal may include light. The signal may include electrical charge. The signal may include sound. The signal may include pressure.

The body portion may include a portion of a finger. The body portion may include a portion of a hand. The body portion may include a portion of a mouth. The body portion may include a portion of an eye. The eye portion may include a portion of an iris. The eye portion may include a portion of a retina. In some embodiments, the body portion may include a portion of a face. The body portion may include a portion of a blood vessel. The blood vessel may be a vein. The blood vessel may be an artery. The blood vessel may be a capillary.

In some embodiments of the invention, the comparing may include identifying a difference between a first template and a second template. The comparing may include identifying a similarity between the first template and the second template. The comparing may include performing a statistical test using a first and a second template. Any suitable statistical test, including any suitable statistical test for quantifying a likelihood of a random match between the first and second templates may be used.

Some embodiments of the invention may include generating a verification report. Some embodiments of the invention may include transmitting the verification report to an entity. The transmitting may include transmitting the report in response to a request from the entity for verification of the identity. The transmitting may include transmitting via an electronic communication network. The entity may be an electronic commerce entity. The entity may be an electronic business entity. The entity may be a health care services entity. The entity may be a pharmaceutical entity. The entity may be a legal services entity. The entity may be a financial services entity. The entity may be a manufacturing entity. The entity may be a high technology design and production entity. The entity may be an educational entity. The entity may be a government entity. The entity may be a transportation entity. The entity may be a private entity. The entity may be a public entity.

In some embodiments, the invention may include receiving the second biometric information from an individual in the presence of the certifier. In some embodiments, the invention may include receiving the identification information from an individual in the presence of the certifier. The invention may include certifying that identification information provided by an individual identifies the individual.

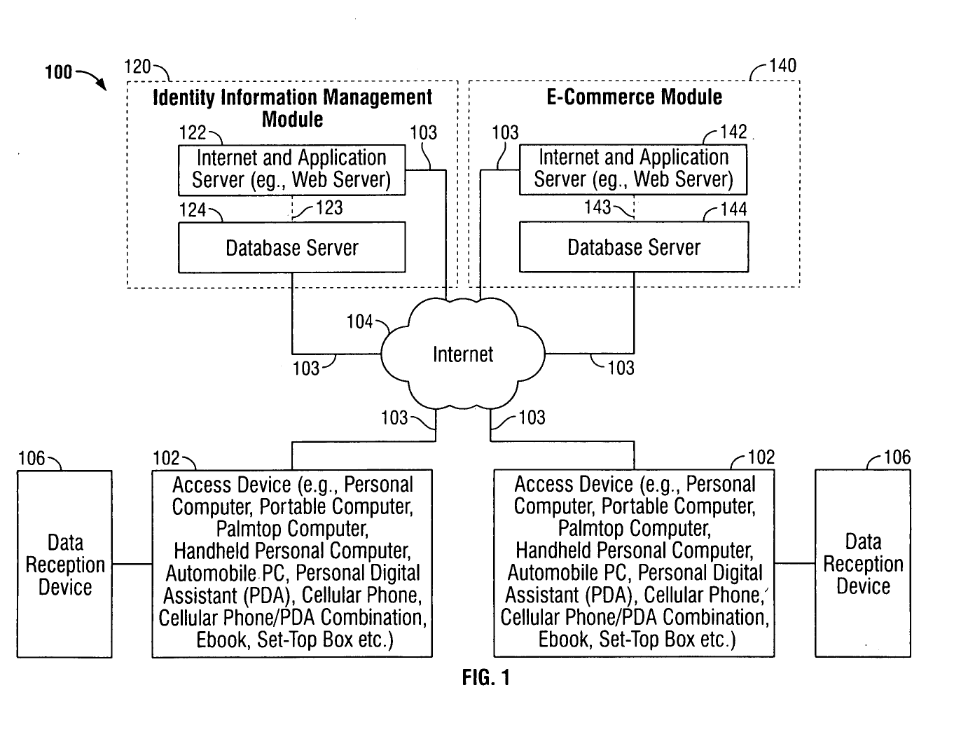

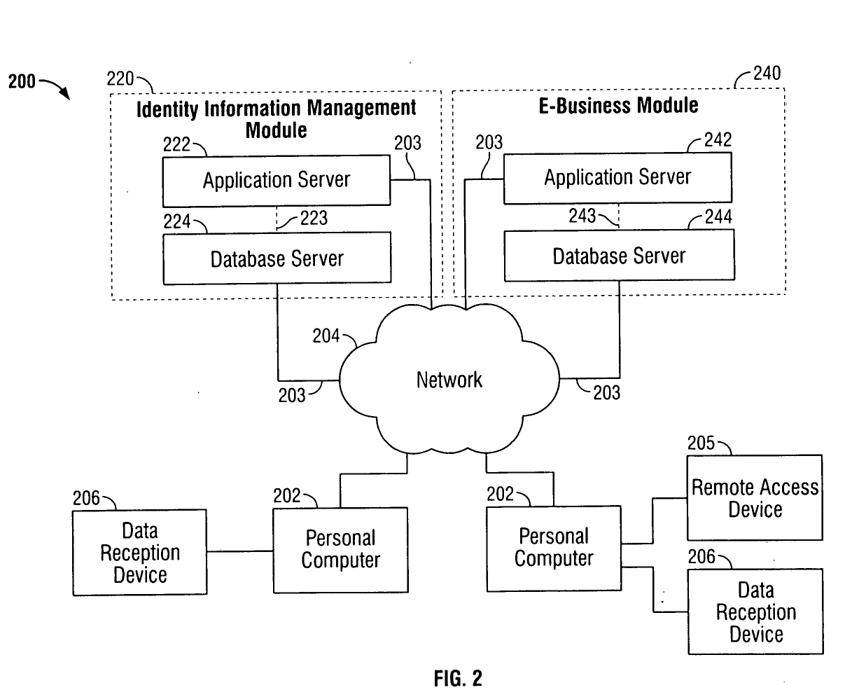

Some embodiments of the present invention may be implemented using any systems or methods suitable for supporting the reception, communication, storage or analysis of information. Some embodiments of the invention may be implemented, for example, using web-based or on-line approaches. In other embodiments, non-on-line client/server or peer-to-peer based approaches may be used. If desired, a combination of these approaches may be used. FIGS. 1 and 2 show, respectively, illustrative Internet and intranet arrangements that may be used for information reception, communication, storage and analysis according to the invention.

FIG. 1 shows illustrative Internet arrangement 100 that may include access devices 102, which may be connected via links 103 to Internet 104. (Although FIG. 1 illustrates arrangement 100 as an Internet-based arrangement, it will be understood that in some embodiments of the invention, arrangement 100 may include any suitable wide area network (“WAN”) in place of, or in addition to, Internet 104.) Access devices 102 may include any device or combination of devices suitable for providing Internet access to a user of arrangement 100. A user may be an individual, a registrant of an identity in an identity information management apparatus, an electronic transaction participant, a certifier, a party or entity seeking to verify an identity or any other suitable party or entity.

Access devices may include, for example, any suitable personal computer (PC), portable computer (e.g., a notebook computer), palmtop computer, handheld personal computer (H/PC), automobile PC, personal digital assistant (PDA), Internet-enabled cellular phone, combined cellular phone and PDA, e-book, or other device suitable for providing Internet access.

Arrangement 100 may include data reception devices 106, which may be in communication with access devices 102. A device 106 may be any suitable device for receiving biometric information. An access device 102 may be in communication with more than one data reception device 106. A device 106 may be a finger print scanner such as that available under the trademark AES 4000 ENTREPAD from Authentic of Melbourne, Florida. A device 106 may be a hand scanner such as that available under the trademark HANDPUNCH 3000 from IR Recognition Systems of Campbell, Calif. A device 106 may be a signature analyzer such as that available under the trademark ESIGN-ENTERPRISE v. 3.0 from Valyd of San Jose, Calif. A device 106 may be a voice analyzer such as that available under the trademark MARTINA from 3 PV of Altamonte Springs, Fla. A device 106 may be a retina scanner such as that available under the trademark NA from Retinal Technologies, Inc. of Boston, Massachusetts. A device 106 may be an iris scanner such as that available under the trademark PRIVATEID from Iridian Technologies of Moorestown, N.J. A device 106 may be a face scanner such as that available under the trademark FACEIT ARGUS from Identix of Minnetonka, Minn.

A device 106 may be any suitable device for receiving identification information. Device 106 may be a card reader such as that available under the trademark 5TH SENSE COMBO from Veridicom International of Vancouver, British Columbia, Canada. Device 106 may be any suitable bar code scanner.

Arrangement 100 may include identity information management apparatus such as identity information management module 120, which may include Internet and application server 122, which may be any server suitable for providing Internet access to, or otherwise communicating with, an identity information management apparatus or an identity information management web site. Internet and application server 122 may run Microsoft Internet Information Server. Internet and application server 122 may, for example, provide one or more pages to an access device 102 using one or more suitable protocols (e.g., the HyperText Transfer Protocol (HTTP) and Transmission Control Protocol/Internet Protocol (TCP/IP)).

The pages may be defined using, for example, any suitable markup language (e.g., HyperText Markup Language (HTML), Dynamic HyperText Markup Language (DHTML), pages defined using the Extensible Markup Language (XML), JavaServer Pages (JSP), Active Server Pages (ASP), or any other suitable approaches). The pages may include scripts, computer code, or subsets of computer code, that define mini-programs (e.g., Perl scripts, Java applets, Enterprise JavaBeans (EJB), or any other suitable approaches). Identity information management module 120 may be designed using any suitable modular approach such as, for example, Java 2 Platform—Enterprise Edition (J2 EE), Component Object Model (COM), Distributed Component Object Model (DCOM), or any other suitable approach.

Database server 124 may run a database management system suitable for managing a database of identity information. Database server 124 may run a database management system suitable for managing a database of biometric information. Database server 124 may include, for example, Microsoft SQL Server, Oracle, or any other suitable database management system such as a Java Database Connectivity (hereinafter, “JDBC”) compliant or an Open Database Connectivity (hereinafter, “ODBC”) compliant database management system. Features of one or both of Internet and application server 122 and database server 124 may be integrated into a single server or may be distributed across multiple servers that are interconnected via Internet 104 or any other suitable communication network.

Links 103 may include any transmission media suitable for providing electronic communication between devices such as access devices 102 and servers 122, 124, 142 and 144. Links 103 may provide Internet access to access devices 102. Links 103 may include, for example, a dial-up telephone line, a computer network or Internet link, an infrared link, a radio frequency link, a satellite link, a digital subscriber line link (e.g., a DSL link), a cable TV link, a DOCSIS link, or any other suitable transmission link or suitable combination of such links. Different links 103 may be of different types depending on, for example, the particular type of access devices 102. In some embodiments of the invention, direct communication link 123 may be present to enable direct communication between servers 122 and 124. Link 123 may have one or more of the features of links 103.

Arrangement 100 may include an e-commerce apparatus such as e-commerce module 140, which may include Internet and application server 142, which may be any server suitable for providing Internet access to or otherwise communicating with an e-commerce apparatus or an e-commerce web site. Internet and application server 142 may run any suitable application or have an suitable feature described in connection with Internet and application server 122.

Database server 144 may run a database management system suitable for managing a database of e-commerce information. Database server 144 may run, for example, Microsoft SQL Server, Oracle, or any other suitable database management system such as a JDBC compliant or an ODBC compliant database management system. Database server 144 may run any suitable application or have any suitable feature described in connection with Internet and application server 122. In some embodiments of the invention, direct communication link 143 may be present to enable direct communication between servers 142 and 144. Link 143 may have one or more of the features of links 103. Features of one or both of Internet and application server 142 and database server 144 may be integrated into a single server or may be distributed across multiple servers that are interconnected via Internet 104 or any other suitable communication network.

Any protocol or protocol stack suitable for supporting communication between access devices 102 and one or both of modules 120 and 140 over links 103 may be used. The protocol or protocol stack may be selected based on a particular device 102 and link 103. For example, Ethernet, Token Group, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), wireless application protocol (WAP), serial line Internet protocol (SLIP), point to point protocol (PPP), Transmission Control Protocol/Internet Protocol (TCP/IP), Sequenced Packet Exchange and Internetwork Packet Exchange (SPX/FPX) protocols, or any other suitable protocol or combination of protocols may be used.

FIG. 2 shows illustrative intranet arrangement 200 that may include network 204, which may be any suitable wire-based, fiber-based or wireless local area network (“LAN”) or other suitable network. Personal computers, and their interconnection via networks, are well known. One or more of personal computers 202 may run suitable e-mail, HTTP, or other clients and client applications for providing network access to a user of arrangement 200. In a suitable approach, one or more personal computers such as 202 may run suitable Internet browsers to provide users with access to the Internet via an Internet server (not shown). If desired, a personal computer 202 may be accessed by remote access device 205 to provide remote access to users to the system. Remote access device 205 may be any suitable device, such as a personal computer, personal digital assistant, cellular phone, or other device with remote access capabilities.

Each of data reception devices 206 may be in communication with one of personal computers 202. A device 206 may be any suitable device for receiving biometric information, including any of the devices described in connection with data reception devices 106 (shown in FIG. 1).

Arrangement 200 may include an identity information management apparatus such as identity information management module 220, which may include application server 222, which may be any server suitable for providing network-based access to, or otherwise communicating with, an identity information management apparatus. Application server 222 may run any suitable application, including any suitable version or versions of the applications described in connection with Internet and application server 122 (shown in FIG. 1), and may have one or more of the features of application server 122. Module 220 may include database server 224, which may run a database management system suitable for managing a database of identify information. Module 220 may include database server 224, which may run a database management system suitable for managing a database of biometric information. Database server 224 may run any suitable version or versions of the applications described in connection with database server 124 (shown in FIG. 1).

Features of one or both of servers 222 and 224 may be integrated into a single server or may be distributed across multiple servers that interconnected via network 204 or any other suitable communication network.

Arrangement 200 may include an e-business apparatus such as e-business module 240, which may include application server 242, which may be any server suitable for providing network-based access to an e-business apparatus. Application server 242 may run any suitable application, including any suitable version or versions of the applications described in connection with Internet and application server 142 (shown in FIG. 1), and may have one or more of the features of Internet and application server 142.

Database server 244 may run a database management system suitable for managing a database of business information. Database server 244 may run any suitable version or versions of the applications in connection with database server 144 (shown in FIG. 1).

Links 203 may include any transmission media suitable for providing electronic communication between devices such as personal computers 202 and servers 222, 224, 242 and 244. Links 203 may provide network access to personal computers 202. Links 203 may include, for example, a dial-up telephone line, a computer network link, an infrared link, a radio frequency link, a satellite link, a digital subscriber line link (e.g., a DSL link), a cable TV link, a DOCSIS link, or any other suitable transmission link or suitable combination of such links. Different links 203 may be of different types depending on, for example, the particular type of personal computer 202.

In some embodiments of the invention, direct communication link 243 may be present to enable direct communication between servers 242 and 244. Link 243 may have one or more of the features of links 203.

Any protocol or protocol stack suitable for supporting communication between personal computers 202 and one or both of modules 220 and 240 over links 203 may be used. The protocol or protocol stack may be selected based on a particular computer 202 and link 203. For example, Ethernet, Token Group, Fiber Distributed Data Interface (FDDI), Circuit-Switched Cellular (CSC), Cellular Digital Packet Data (CDPD), RAM mobile data, Global System for Mobile communications (GSM), time division multiple access (TDMA), code division multiple access (CDMA), wireless application protocol (WAP), serial line Internet protocol (SLIP), point to point protocol (PPP), Transmission Control Protocol/Internet Protocol (TCP/IP), Sequenced Packet Exchange and Internetwork Packet Exchange (SPX/FPX) protocols, or any other suitable protocol or combination of protocols may be used.

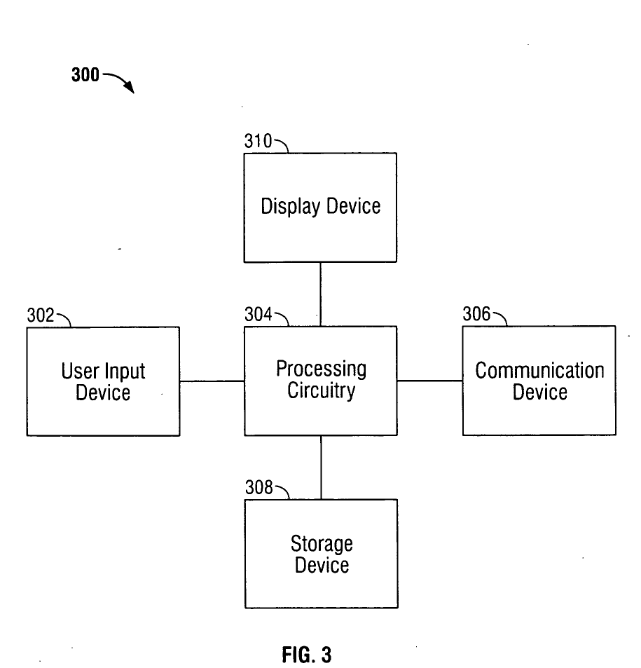

FIG. 3 shows illustrative, generalized arrangement 300 for one or more of access devices 102 (shown in FIG. 1), personal computers 202 and remote access device 205 (shown in FIG. 2). Arrangement 300 may include, for example, user input device 302, processing circuitry 304, communication device 306, storage device 308, and display device 310. User input device 302 may be any suitable input device. User input device 302 may include, for example, a pointing device, a keyboard, a scanner, a camera, a touch-pad, a touch screen, a pen stylus, a voice recognition system, a mouse, a trackball, a joystick or any other suitable user input device.

Processing circuitry 304 may include any suitable processor or processors, such as one or more of those sold under the trademarks INTEL and PENTIUM by Intel Corporation of Santa Clara, Calif., any suitable microprocessor, and any other suitable circuitry (e.g., input/output (I/O) circuitry, direct memory access (DMA) circuitry, etc.). Communication device 306 may be any device suitable for supporting communications over links 103 (shown in FIG. 1) or 203 (shown in FIG. 2). Communication device 306 may include, for example, a modem (e.g., any suitable analog or digital standard, cable, or cellular modem), a network interface card (e.g., an Ethernet card, token group card, etc.), a wireless transceiver (e.g., an infrared, radio, or any other suitable analog or digital transceiver), or any other suitable communication device. Storage device 308 may be any suitable memory, storage device, or combination thereof, such as RAM, ROM, flash memory, a hard disk drive, etc. Display device 310 may include, for example, a cathode ray tube (CRT) monitor, liquid crystal display (LCD), voice synthesis processor and speaker, or any other suitable user output device.

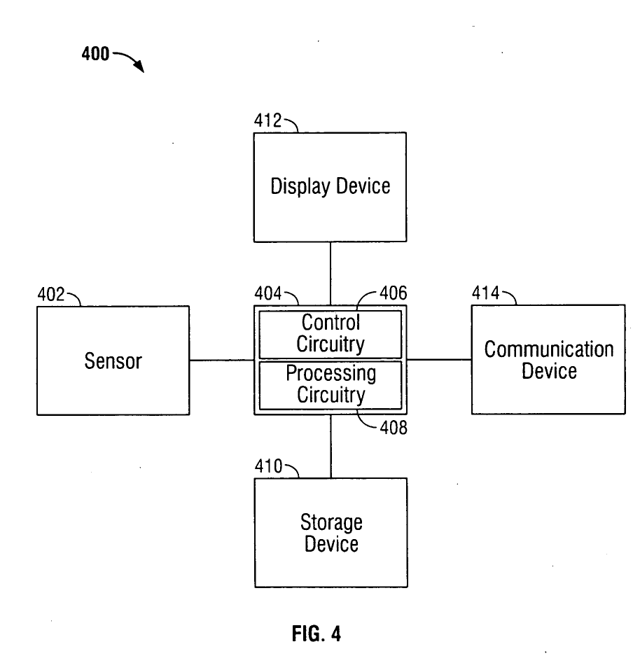

FIG. 4 shows illustrative generalized arrangement 400 for one or more of data reception devices 106 and 206 (shown in FIGS. 1 and 2, respectively). Arrangement 400 may be configured to receive a biometric signal from a body, which may be a human body. Arrangement 400 may include sensor 402, which may be any suitable sensor for receiving biometric information from the body. Sensor 402 may sense any feature of the body that may provide a biometric signal. For example, sensor 402 may sense one or more of light intensity, light color, pressure, capacitance, charge, heat, sound and any other suitable quantity. Sensor 402 may include any sensor that may be present in devices 106 and 206 as described above.

Arrangement 400 may include processor 404, which, in some embodiments of the invention, may include any of the features described in connection with circuitry 304. Processor 404 may include control circuitry 406 for controlling sensor 402. Processor 404 may include processing circuitry 408 for processing a biometric information signal received by sensor 402. Processor 404 may process biometric information for communication to another device. Arrangement 400 may include storage device 410, which may store any suitable instructions or parameters that may be required by control circuitry 406. Device 410 may store biometric information. Arrangement 400 may include display device 412, which may provide a user with any suitable message. The message may instruct a user to provide the signal to sensor 402. The message may inform the user that the signal was properly received. The message may inform the user that the signal was not properly received. Arrangement 400 may include communication device 414. Communication device 414 may provide biometric information to another device, such as that represented by arrangement 300 (shown in FIG. 3).

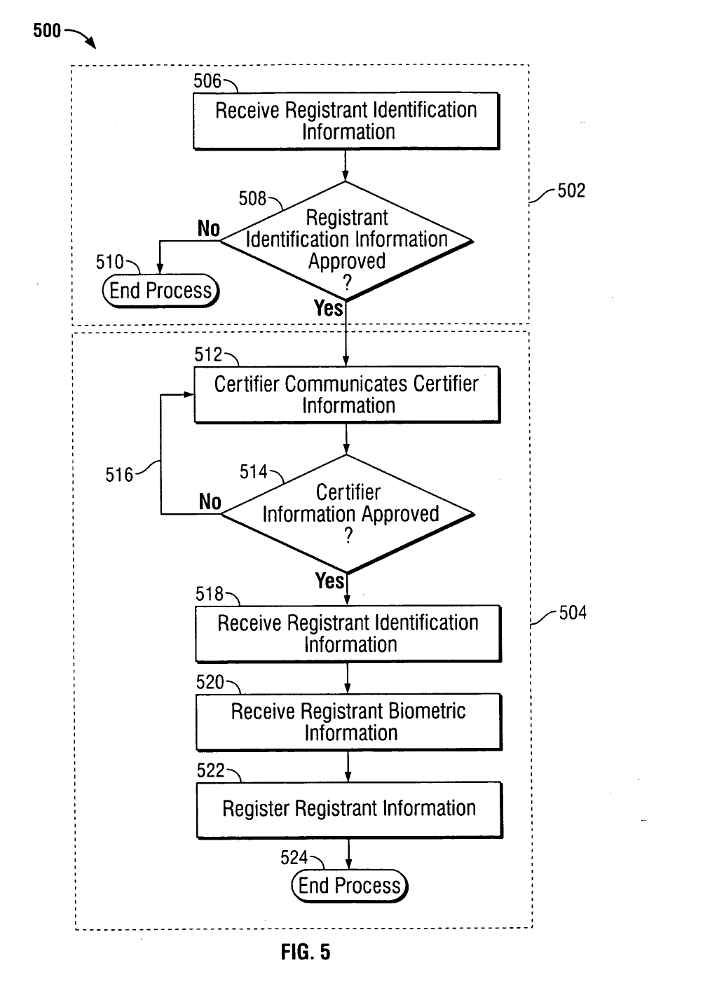

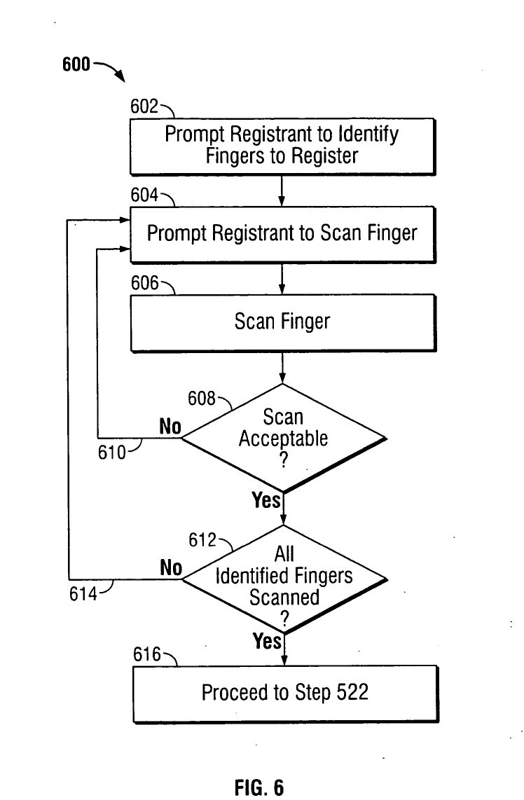

FIGS. 5-6 show general flowcharts of illustrative steps that may be performed, in accordance with the principles of the invention, for registering biometric information in an identity information management apparatus. The steps shown in FIGS. 5-6 are only illustrative and may be performed in any suitable order. In practice, there may be additional steps or some of the steps may be deleted. Some of the steps shown in FIGS. 5-6 may involve providing a user with opportunities to interact with the identity information management apparatus, performing various processes, or providing various displays. Some of these steps and other steps may be performed by, for example, a client application that is programmed to generate or download screens suitable to provide such opportunities, an Internet browser that downloads suitable pages to provide such opportunities, peer applications, or using any other suitable approach.

In an Internet arrangement such as 100 (shown in FIG. 1), one or more of access devices 102, for example, may be used to run client-based applications, such as a web browser. In an intranet arrangement such as 200 (shown in FIG. 2), one or more of personal computers 202, for example, may run one or more client-based applications.

In arrangement 100 (shown in FIG. 1), some of the steps shown in FIGS. 5-6 may be performed, for example, by an access device 102, a data reception device 106, identity information management module 120, Internet and application server 122, or database server 124, depending on, for example, the processing and storage capabilities of access device 102, the chosen implementation for the markup language documents used, the processing requirements of such operations, or other factors.

In an intranet arrangement such as 200 (shown in FIG. 2), such processing may be performed by a personal computer 202, a data reception device 206, remote access device 205, application server 242, and database server 244. The processing may be distributed among peer applications, depending on the chosen system implementation and the processing requirements of such operations. In some embodiments of the invention, some steps may be performed by a certifier. The certifier may be a human being.

For clarity, the following discussion will describe the steps shown in FIG. 5-6 as being performed by an “identity registration system,” which is intended to include any suitable information processing system, such as, for example, all or portion of arrangements 100 and 200 (shown in FIGS. 1 and 2, respectively). In some embodiments of the invention, the identity registration system may include a certifier.

Illustrative identity registration process 500 may be used to register biometric information from a registrant and identification information provided by the registrant. Process 500 may be used to register an association between the biometric and identification information. Process 500 may include steps 502, which may be performed by a certifier. In step 506, the certifier may receive from the registrant any suitable form of identification information. In step 508, the certifier may approve or disapprove the identification information. The approval or disapproval may be based on any suitable standard.

If the identification information is disapproved, registration process 500 may be terminated in step 510. If the identification information is approved, process 500 may continue in steps 504, which may be performed by one or more of an access device 102, a data reception device 106, identity information management module 120 (all shown in FIG. 1), a personal computer 202, a data reception device 206 and information management module 220 (all shown in FIG. 2).

In step 512, the certifier may communicate certifier information to an identity information management module such as 120 or 220. (As used herein, “certifier information” is information concerning a certifier and “certifying information” is information that may be used to certify one or both of identification and biometric information.) The certifier information may include certifier biometric information. The biometric information may be communicated via a data reception device such as 106 (shown in FIG. 1) or 206 (shown in FIG. 2). The certifier information may include certifier identification information. The certifier information may be communicated via a device such as an access device 102 (shown in FIG. 1) or personal computer 202 (shown in FIG. 2).

In step 514, the identity registration system may approve or disapprove the certifier information. The system may approve or disapprove based on a comparison between the communicated certifier information and stored certifier information that may be present in a database on a database server such as 124 or 224 (shown in FIGS. 1 and 2, respectively). The stored certifier information may include certifier biometric information. The stored certifier information may include certifier identification information. In some embodiments of the invention, the system may approve the communicated certifier information if a portion of the communicated certifier information matches a portion of the stored certifier information.

If the identity registration system does not approve the communicated certifier information, process 500 may return along path 516 to step 512. If the identity registration system approves the communicated certifier information, process 500 may proceed to step 518, in which the identification registration system may receive registrant identification information from the registrant. The registrant identification information may be the registrant identification information received by the certifier in step 506. In step 520, the identification registration system may receive registrant biometric information. In step 522, registrant information, which may include one or both of the registrant identification information and the registrant biometric information, may be registered in an identity information management apparatus.

In some embodiments of the invention, step 522 may include providing the certifier with an opportunity to instruct the identity registration system to register the registrant identification and biometric information. In some embodiments of the invention, step 522 may include providing an assurance that the opportunity to instruct the identity registration system to register the information is provided only to the certifier and not a different party. The assurance may include an additional step (not shown) for approving the certifier information. The assurance may include providing the opportunity via a device to which the registrant does not have access.

In some embodiments of the invention, step 522 may include providing the certifier with an opportunity to certify that the registrant identification information identifies the registrant. In some embodiments of the invention, step 522 may include providing the certifier with an opportunity to certify that the registrant biometric information identifies the registrant.

In some embodiments, the identity registration system may provide confirmation that the registrant information was successfully registered. Process 500 may be terminated in step 524.

FIG. 6 shows illustrative process 600 that includes steps that may be involved in performing step 520 of process 500 (shown in FIG. 5). Process 600 will be illustrated in the context of finger-print-based identification registration, but it will be understood that embodiments of the invention may involve identification registration based on any suitable biometric information. In step 602, the identity registration system may prompt the registrant to identify one or more fingers to be the subject of a registration.

For example, the identity registration system may prompt the registrant to identify a number of fingers. The fingers may be identified, for example, by identifying a hand and a finger number corresponding to the finger. The identity registration system may provide the registrant with a display showing fingers and corresponding labels identifying the fingers. In some embodiments of the invention, the display may include selectable display objects corresponding to the fingers. In those embodiments, the registrant may use a user input device such as a mouse to select one or more of the objects.

In step 604, the identity registration system may prompt the registrant to scan a finger, for example, using a device such as one of data reception device 106 and data reception device 206. In step 606, a scan of the finger may be performed. In some embodiments of the invention, the identity registration system may initiate the scan. In some embodiments of the invention, a user may initiate the scan. The user may be the registrant. The user may be the certifier. The user may be any other suitable person.

In step 608, the identity registration system may accept or reject the scan. If the scan is rejected, process 600 may return to step 604 via path 610. If the scan is accepted, the identity registration system may, at step 612 (if the identity registration system has not yet scanned the fingers identified in step 602), return to step 604 to scan another finger. If the scan is accepted and the identity registration system has scanned all of the fingers identified in step 602, process 600 may terminate and the identity registration system may resume process 500, for example at step 522.

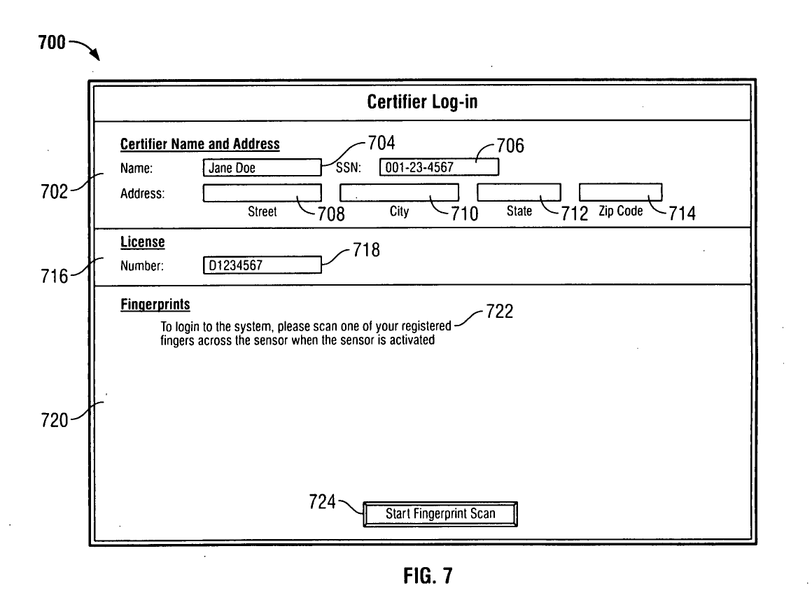

FIGS. 7-9 show illustrative displays that may be provided by an identity registration system such as that which may perform processes 500 and 600 (shown in FIGS. 5 and 6, respectively). The identity registration system may display the illustrative displays, and may display any other suitable displays, via an access device 102, a personal computer 202, remote access device 205 or any other suitable device.

FIGS. 7-9 show information and features in one arrangement for the sake of illustration. The information and features may be arranged in any suitable manner and displayed in any suitable display or displays. The displays shown in one or more of FIGS. 7-9 may include one or more electronic forms.

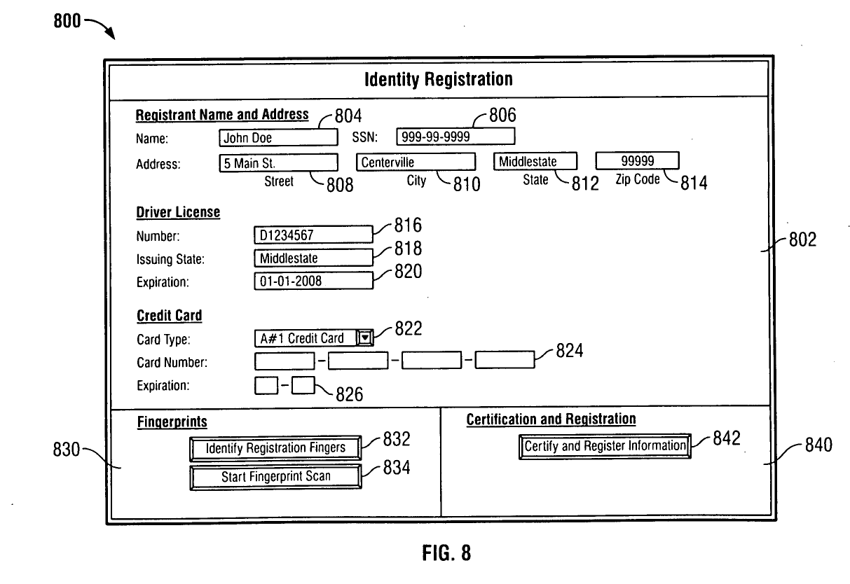

FIGS. 7-8 show text input boxes for receiving information from a user of the identity registration system. It will be understood that text input boxes are shown for illustrative purposes only and that any suitable data entry feature may be used for receiving the information. FIGS. 7-8 show radio buttons for receiving from the user an instruction to perform a process step such as one of those shown in FIGS. 5 and 6. It will be understood that radio buttons are shown for illustrative purposes only and that any suitable display-based process control feature may be provided for receiving the instruction. FIGS. 7-8 show illustrative features of an identity registration system in the context of finger-print-based identification registration, but it will be understood that embodiments of the invention may involve identification registration based on any suitable biometric information.

FIG. 7 shows illustrative display 700 that may be used in some embodiments of the invention to provide a certifier with an opportunity to communicate certifier information to an identity information management apparatus. Display 700 may include portion 702, in which the certifier may enter certifier identification information that identifies the certifier. Portion 702 may include text input boxes 704, 706, 708, 710, 712 and 714 for receiving a name, a social security number, a street address, a city, a state and a zip code, respectively. Portion 702 may include a data entry feature for any suitable certifier identification information.

Display 700 may include portion 716 in which the certifier may enter license information that identifies a license that may be held by the certifier. The license may be a notary public license. The license may be a driver's license. Portion 716 may include a text input box for receiving a license number for the license. Portion 716 may include text input boxes for receiving a license number for more than one license. Portion 716 may include a data entry feature for any suitable license information. In some embodiments of the invention, portions 702 and 716 be used in conjunction with steps 502 of process 500 (shown in FIG. 5).

Display 700 may include portion 720 in which the identification registration system may provide instructions such as 722 to instruct the certifier to scan a registered finger using a sensor. Portion 720 may include radio button 724 for initiating a scan of a certifier finger. The registered finger may be a finger for which biometric information was registered in an identity information management apparatus prior to the commencement of process 500. In some embodiments of the invention, portion 720 may be used in conjunction with step 512 of process 500 (shown in FIG. 5).

FIG. 8 shows illustrative display 800 that may be used in some embodiments of the invention to receive registrant identification information and registrant biometric information. Display 800 may include portion 802, which may be used to receive registrant identification information. The registration identification information may include, in text input boxes 804, 806, 808, 810, 812 and 814, a registrant name, a registrant social security number, a registrant street address, a registrant city, a registrant state and a registrant zip code, respectively. Text input boxes 816, 818 and 820 may be used to receive, for example, a driver's license number, an issuing state and a license expiration date, respectively. Drop down box 822 and text input boxes 824 and 826 may be used to receive a registrant selection of a credit card type, a credit card number and a credit card expiration date, respectively. In some embodiments of the invention, the identification information received in boxes such as 822, 824 and 826 may be used to bill the registrant for an identity registration fee.

Display 800 may include portion 830, which may be used to receive registrant biometric information. Portion 830 may include radio button 832, which may be used to receive a user instruction to initiate a process for identifying fingers to register. Portion 830 may include radio button 834, which may be used to receive a user instruction to initiate a fingerprint scan.

Display 800 may include portion 840, which may include radio button 842, which may be used to receive an instruction to register information received via portions 802 and 830 in an identity information management apparatus. The certifier may click on button 836 to certify the information received via portions 802 and 830 in some embodiments of the invention, thereby transmitting certifying information. The certifier may certify the information in conformance with any suitable standard for electronic certification. Information received via portions 802 and 830 may be used, for example, in connection with steps 518 and 520 of process 500 (shown in FIG. 5). Button 836 may be used, for example, in connection with step 522 of process 500.

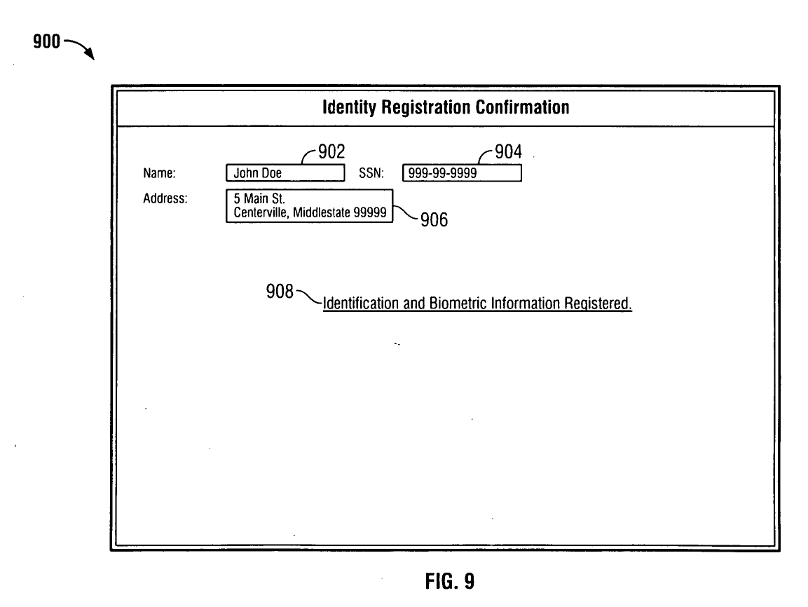

FIG. 9 shows illustrative display 900 that may be used in some embodiments of the invention to communicate to a user that identification information, for example that received via portion 802 (shown in FIG. 8), and biometric information, for example that received via portion 830 (shown in FIG. 8) have been registered by the identity information management system. Text display boxes 902, 904 and 906 may include information received via portion 802 (shown in FIG. 8). Message 908 may confirm that registrant identification information and registrant biometric information were registered in the identity information management system. Display 900 may include any other suitable information. Display 900 may include any other suitable message.

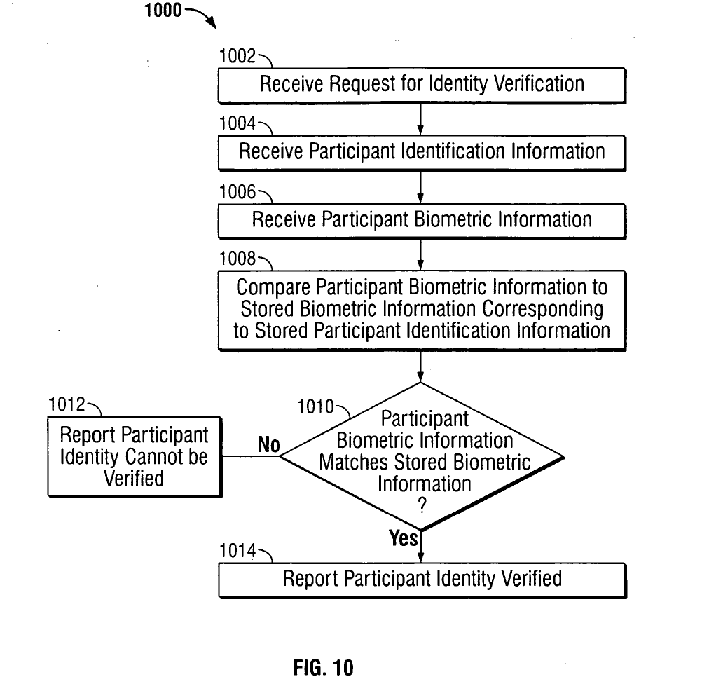

FIG. 10 shows a general flowchart of illustrative steps that may be performed, in accordance with the principles of the invention, for verifying an identity of a participant in an electronic transaction. The steps shown in FIG. 10 are only illustrative and may be performed in any suitable order. In practice, there may be additional steps or some of the steps may be deleted. Some of the steps shown in FIG. 10 may involve providing a user with an opportunity to interact with an identity information management apparatus, performing various processes, or providing various displays. Some of these steps and other steps may be performed by, for example, a client application that is programmed to generate or download screens suitable to provide such opportunities, an Internet browser that downloads suitable pages to provide such opportunities, peer applications, or using any other suitable approach.

In an Internet arrangement such as 100 (shown in FIG. 1), one or more of access devices 102, for example, may be used to run client-based applications, such as a web browser. An e-commerce module such as 140 may function as a client of an identity information management module such as 100. For example, e-commerce module 140 may provide a request for a verification of an identity of a participant in an Internet-based transaction to identity information management module 100.

In an intranet arrangement such as 200 (shown in FIG. 2), one or more of personal computers 202, for example, may run one or more client-based applications. An e-business module such as 240 may function as a client of an identity information management module such as 200. For example, an e-business module such as 240 may provide a request for a verification of an identity of a participant in an electronic transaction to identity information management module 200.

In an Internet arrangement such as 100 (shown in FIG. 1), some of the steps shown in FIG. 10 may be performed, for example, by an access device 102, a data reception device 106, identity information management module 120, Internet and application server 122, or database server 124, depending on, for example, the processing and storage capabilities of access device 102, the chosen implementation for the markup language documents used, the processing requirements of such operations, or other factors.

In an intranet arrangement such as 200 (shown in FIG. 2), some of the steps shown in FIG. 10 may be performed by a personal computer 202, a data reception device 206, remote access device 205, application server 242, and database server 244. Processing required for performance of the steps may be distributed among peer applications, depending on the chosen system implementation and the processing requirements of such operations.

For clarity, the following discussion will describe the steps shown in FIG. 10 as being performed by an “identity verification system,” which is intended to include any suitable system, such as, for example, all or a portion of arrangements 100 and 200 (shown in FIGS. 1 and 2, respectively). In some embodiments of the invention, the identity verification system may include a certifier, which may be a human being.

Illustrative identity verification process 1000 may be used to verify a correspondence between biometric information received from a transaction participant and stored biometric information. The stored biometric information may be stored in an identity information management apparatus. In step 1002, the identity verification system may receive a request to verify the identity of a transaction participant based on biometric information provided by the participant. In step 1004, the identity verification system may receive participant identification information. In step 1006, the identity verification system may receive participant biometric information. In step 1008, the identify verification system may compare the participant biometric information to stored biometric information corresponding to the received participant identification information.

If, in step 1010, the received biometric information does not match the stored biometric information, the identity verification system may report that the participant identity can not be verified. In some embodiments of the invention, a report may include an electronic document that may be provided to an e-commerce module such as 140 or an e-business module such as 240 (shown in FIGS. 1 and 2, respectively).

If, in step 1010, the received biometric information does match the stored biometric information, the identity verification system may report that the participant identity is verified. In some embodiments of the invention, the identity verification system may report that the participant identity is verified only if the received identity information matches the stored identity information and the received biometric information matches the stored biometric information.

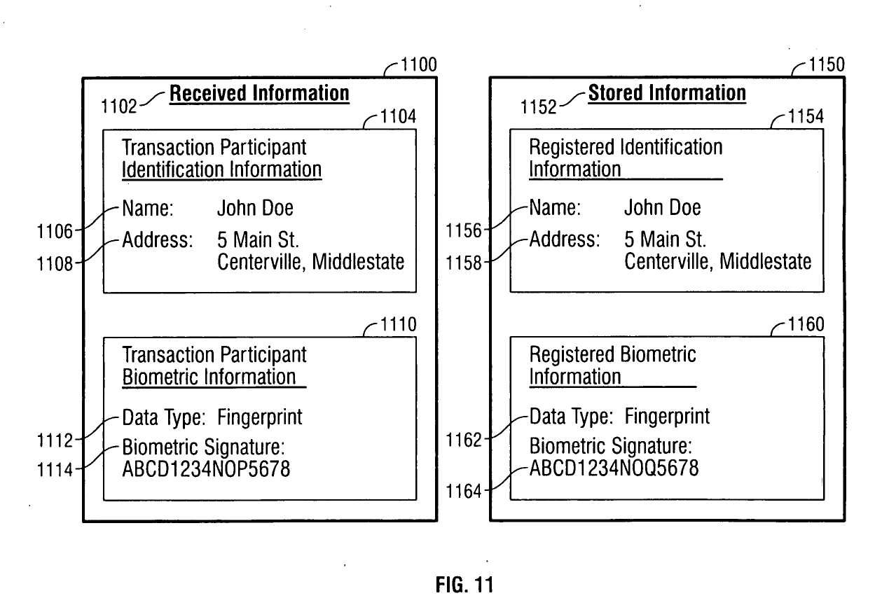

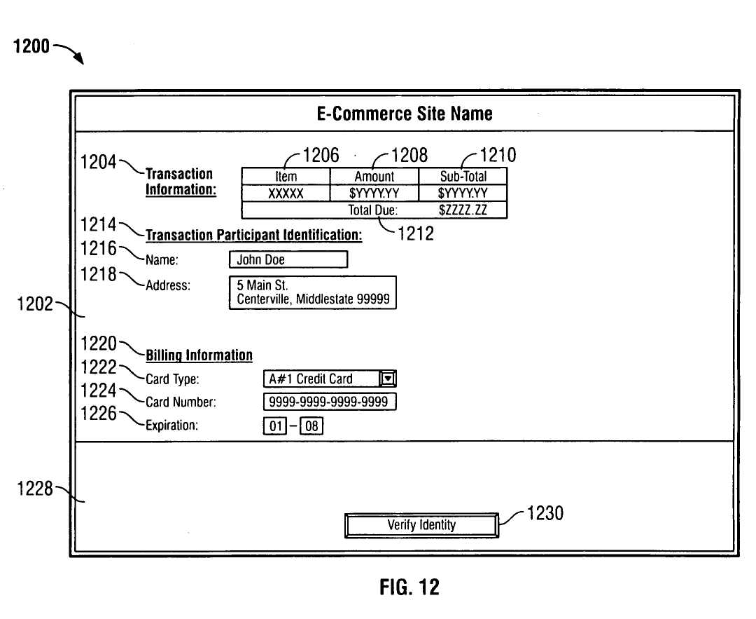

FIGS. 11-12 show illustrative features of an identity verification system in the context of finger-print-based identification verification, but it will be understood that embodiments of the invention may involve identification registration based on any suitable biometric information.

FIG. 11 shows illustrative data records 1100 and 1150 that may be involved in process 1000 (shown in FIG. 10). Record 1100 may be representative of data that may be received by an identity registration system such as that which may perform process 1000 (shown in FIG. 10). Record 1150 may be representative of data that may be stored by such an identity registration system. It will be understood that the data shown in FIG. 11 are for illustrative purposes only. The data that may be stored in, and the data that may be received by, the identity registration system are not necessarily limited to the amount of data or types of data shown in FIG. 11. Data such as those shown in record 1150 may be stored in a database on a database server such as 124 or 224 (shown in FIGS. 1 and 2, respectively), may be stored in any suitable data structures, arranged in any suitable manner and displayed in any suitable manner.

Record 1100 may include received information 1102, which may include transaction participant identification information 1104, which may be received by the identity verification system in step 1004. Identification information 1104 may include any suitable information that may be provided by the transaction participant to the identity verification system. Information 1104 may include name information 1106. Information 1104 may include address information 1108. Information 1104 may include any of the information shown in, or described in connection with, illustrative display 800 (shown in FIG. 8).

Received information 1102 may include transaction participant biometric information 1110, which may be received by the identity verification system in step 1006. Biometric information 1110 may include data type information 1112 that may be used to show the type of biometric information present in record 1100. In the example illustrated in FIG. 11, data type information 1112 is fingerprint data. Information 1110 may include biometric signature 1114, which may be a representation of a signal received by a data reception device such as a device 106 or a device 206 (shown in FIGS. 1 and 2, respectively). In the example illustrated in FIG. 11, biometric signature 1114 is an alphanumeric representation of a minutia template.

The identity verification system may search for a stored record that includes registered identification information that matches transaction participant identification information 1104 of received record 1100. FIG. 11 shows that record 1150 may include information 1152, which may include registered identification information 1154 and registered biometric information 1160. The identity verification system may identify record 1150 and compare it to record 1100 in a step such as 1008 of process 1000 (shown in FIG. 10).

Information 1154 and information 1160 may be stored by the identity verification system prior to the performance of step 1102. Identification information 1154 and biometric information 1160 may be stored, for example, in connection with an identity registration process that registers identification information and biometric information in a database. One example of such a process is described in connection with process 500 (shown in FIG. 5), but identification information 1154 and biometric information 1160 may be stored via any process that stores identification information and biometric information.

Identification information 1154 may include any suitable identification information. Identification information 1154 may include name information 1156 and address information 1158. In the example shown in FIG. 11, name information 1156 matches name information 1106 and address information 1158 matches address information 1108. Identification information 1154 of stored information 1152 therefore matches identification information 1104 of received information 1102.

Registered biometric information 1160 may include any suitable biometric information. Biometric information 1160 may include data type information 1162, which may be used to show the type of biometric information present in record 1150.

In the example illustrated in FIG. 11, data type information 1162 is fingerprint data. Biometric information 1160 may include registered biometric signature 1164, which may be a representation of a signal received by a data reception device such as a device 106 or a device 206 (shown in FIGS. 1 and 2, respectively). In the example illustrated in FIG. 11, biometric signature 1114 may an alphanumeric representation of a minutia template. In the example illustrated in FIG. 11, biometric signature 1164 of stored information 1152 does not match biometric signature 1114 of received information 1102 because the character “Q” in signature 1164 does not match the character “P” in signature 1114.

FIG. 12 shows illustrative display 1200 that may be displayed by a device such as an access device 102 or a personal computer 202 (shown in FIGS. 1 and 2, respectively). Display 1200 may include an electronic form. In some embodiments of the invention, display 1200 may be provided by an e-commerce module such as 140 or an e-business module such as 240 (shown in FIGS. 1 and 2, respectively). In some embodiments of the invention, display 1200 may be provided by an identity information management module such as 100 or 200 (shown in FIGS. 1 and 2, respectively). In some embodiments of the invention, display 1200 may be displayed by an identity registration system such as that which may perform process 1000 (shown in FIG. 10).

In some embodiments of the invention, display 1200 may include information provided by both the e-commerce module and the identity information management module. In some embodiments of the invention, display 1200 may include information provided by both the e-business module and the identity information management module.

In some embodiments of the invention, display 1200 may be displayed to the transaction participant as part of a payment or electronic check-out process. In the example shown in FIG. 12, the transaction may be a purchase of an item from an Internet e-commerce web site such as may be provided by e-commerce module 140 (shown in FIG. 1). In another example (not shown), the transaction may be a transfer of funds between accounts using an e-business system such as may be provided by e-business module 240 (shown in FIG. 2).

Display 1200 may include portion 1202, which may include transaction information 1204. Transaction information 1204 may include any suitable information regarding the transaction. In the example of FIG. 12, transaction information 1204 may include item identifier 1206, which may identify an item that is the subject of the transaction. Transaction information 1204 may include amount 1208 to be paid for the item. Transaction information 1204 may include subtotal information 1210, which may correspond to amount 1208. Transaction information 1204 may include total due information 1212, which may include a total amount due for all items that may be involved in the transaction.

Portion 1202 may include transaction participant identification information 1214, which may include name 1216 and address 1218, which may correspond to information in one or both of records 1100 and 1150 (shown in FIG. 11). Portion 1202 may include billing information 1220 that may be used by the e-commerce web site to bill the participant for purchased items. Billing information 1220 may include any suitable billing information, including card type information 1222, card number information 1222 and card expiration date information 1226.

Display 1200 may include portion 1228, which may include process control feature 1230. Process control feature 1230 may be present to receive an instruction from the participant to verify the identity of the participant. Although process control feature 1230 is illustrated as a radio button, process control feature 1230 may be any suitable electronic display-based process control feature. The participant may activate process control feature 1230 to initiate a process such as process 1100 (shown in FIG. 11).

Thus it is seen that apparatus and methods for registering biometric information in an identity information management apparatus and for verifying the identity of a participant in an electronic transaction have been provided. One skilled in the art will appreciate that the present invention can be practiced by other than the described embodiments, which are presented for purposes of illustration and not of limitation, and the present invention is limited only by the claims which follow.

1. A method for registering biometric information in an information management apparatus, said method comprising:
receiving said biometric information from an individual;
receiving identification information from said individual; and
certifying that said identification information identifies said individual.

2. The method of claim 1 wherein said biometric information comprises a digitized template.

3. The method of claim 2 wherein said digitized template comprises a minutia template.

4. The method of claim 2 wherein said digitized template is in conformance with a standard.

5. The method of claim 4 wherein said standard is a CBEFF standard.

6. The method of claim 2 wherein said digitized template comprises a voice print.

7. The method of claim 2 wherein said digitized template comprises a face print.

8. The method of claim 2 wherein said digitized template comprises an iris scan.

9. The method of claim 2 wherein said digitized template comprises a retina scan.

10. The method of claim 2 wherein said digitized template comprises a hand scan.

11. The method-of claim 2 wherein said digitized template comprises a signature scan.

12. The method of claim 1 wherein said receiving said biometric information comprises prompting said individual to provide said biometric information.

13. The method of claim 1 further comprising providing a device configured to receive a signal from a portion of said individual.

14. The method of claim 13 wherein said signal comprises an image.

15. The method of claim 13 wherein said signal comprises light.

16. The method of claim 13 wherein said signal comprises electrical charge.

17. The method of claim 13 wherein said signal comprises sound.

18. The method of claim 13 wherein said signal comprises pressure.

19. The method of claim 13-wherein said portion comprises at least a portion of a finger.

20. The method of claim 13 wherein said portion comprises at least a portion of a hand.

21. The method of claim 20 wherein said signal is transmitted from said hand to said device via an instrument.

22. The method of claim 21 wherein said instrument is a stylus.

23. The method of claim 21 wherein said instrument is a writing instrument.

24. The method of claim 13 wherein said portion comprises at least a portion of a mouth.

25. The method of claim 13 wherein said portion comprises at least a portion of an eye.

26. The method of claim 13 wherein said portion comprises at least a portion of an iris.

27. The method of claim 13 wherein said portion comprises at least a portion of a retina.

28. The method of claim 13 wherein said portion comprises at least a portion of a face.

29. The method of claim 13 wherein said portion comprises at least a portion of a blood vessel.

30. The method of claim 1 further comprising transmitting said biometric information to said apparatus, said apparatus configured to verify an identity of said participant.

31. The method of claim 1 wherein said certifying comprises confirming at least a portion of said identification information.

32. The method of claim 31 wherein said portion comprises an address.

33. The method of claim 31 wherein said portion comprises a name.

34. The method of claim 31 wherein said portion comprises a date of birth.

35. The method of claim 31 wherein said portion comprises an identification number.

36. The method of claim 35 wherein said identification number is a social security number.

37. The method of claim 31 wherein said portion comprises license information.

38. The method of claim 37 wherein said license information comprises automobile driver's license information.

39. The method of claim 1 further comprising providing a certifier; wherein said receiving said biometric information comprises receiving said biometric information from said individual in the presence of said certifier.

40. The method of claim 1 further comprising providing a certifier; wherein said receiving identification information comprises receiving said identification information from said individual in the presence of said certifier.

41. The method of claim 40 wherein said certifying comprises certifying that said individual presented said identification information.

42. The method of claim 1 wherein said certifying comprises verifying the identity of a certifier.

43. The method of claim 38 wherein said verifying comprises:
receiving first certifier biometric information from said certifier; and
comparing said first certifier biometric information to second biometric information.

44. The method of claim 38 further comprising providing a certificate to said certifier.

45. The method of claim 44 wherein said certificate is a license.

46. The method of claim 42 wherein said certifier is a notary public.

47. The method of claim 1 wherein said certifying comprises notarizing a document.

48. The method of claim 47 wherein said notarizing comprises electronically notarizing said document.

49. The method of claim 48 wherein said document is an electronic document.

50. A method for verifying an identity of a participant in an electronic transaction, said method comprising:
receiving over an electronic communication network first physical biometric information received from said participant; and
comparing said first physical biometric information to second biometric information.

51. The method of claim 50 further comprising retrieving said second biometric information from a data storage device.

52. The method of claim 50 wherein said first physical biometric information comprises a first digitized template.

53. The method of claim 52 wherein said digitized template comprises a minutia template.

54. The method of claim 52 wherein said digitized template is in conformance with a standard.

55. The method of claim 54 wherein said standard is a CBEFF standard.

56. The method of claim 52 wherein said digitized template comprises a voice print.

57. The method of claim 52 wherein said digitized template comprises a face print.

58. The method of claim 52 wherein said digitized template comprises an iris scan.

59. The method of claim 52 wherein said digitized template comprises a retina scan.

60. The method of claim 52 wherein said digitized template comprises a hand scan.

61. The method of claim 50 wherein said second biometric information comprises a second digitized template.

62. The method of claim 61 wherein said digitized template comprises a minutia template.

63. The method of claim 61 wherein said digitized template is in conformance with a standard.

64. The method of claim 63 wherein said standard is a CBEFF standard.

65. The method of claim 61 wherein said digitized template comprises a voice print.

66. The method of claim 61 wherein said digitized template comprises a face print.

67. The method of claim 61 wherein said digitized template comprises an iris scan.

68. The method of claim 61 wherein said digitized template comprises a retina scan.

69. The method of claim 61 wherein said digitized template comprises a hand scan.

70. The method of claim 50 wherein said receiving comprises receiving data in conformance with a format.

71. The method of claim 70 wherein said format comprises a markup language format.

72. The method of claim 71 wherein said format comprises Hyper Text Markup Language.

73. The method of claim 71 wherein said format comprise Extensible Markup Language.

74. The method of claim 70 wherein said receiving comprises transferring data in conformance with a file transfer protocol.

75. The method of claim 74 wherein said protocol comprises the File Transfer Protocol.

76. The method of claim 74 wherein said protocol comprises an electronic mail protocol.

77. The method of claim 76 wherein said mail protocol comprises the Simple Mail Transfer Protocol.

78. The method of claim 74 wherein said protocol comprises Hyper Text Transfer Protocol.

79. The method of claim 50 wherein said receiving comprises prompting said participant to provide said first biometric information.

80. The method of claim 50 further comprising providing a device configured to receive a signal from a portion of said participant.

81. The method of claim 80 wherein said signal comprises an image.

82. The method of claim 80 wherein said signal comprises light.

83. The method of claim 80 wherein said signal comprises electrical charge.

84. The method of claim 80 wherein said signal comprises sound.

85. The method of claim 80 wherein said signal comprises pressure.

86. The method of claim 80 wherein said portion comprises at least a portion of a finger.

87. The method of claim 80 wherein said portion comprises at least a portion of a hand.

88. The method of claim 80 wherein said portion comprises at least a portion of a mouth.

89. The method of claim 80 wherein said portion comprises at least a portion of an eye.

90. The method of claim 80 wherein said portion comprises at least a portion of an iris.

91. The method of claim 80 wherein said portion comprises at least a portion of a retina.

92. The method of claim 80 wherein said portion comprises at least a portion of a face.

93. The method of claim 80 wherein said portion comprises at least a portion of a blood vessel.

94. The method of claim 50 wherein said comparing comprises identifying a difference between a first digitized template and a second digitized template.

95. The method of claim 50 wherein said comparing comprises identifying a similarity between a first digitized template and a second digitized template.

96. The method of claim 50 wherein said comparing comprises performing a statistical test using a first digitized template and a second digitized template.

97. The method of claim 50 further comprising providing a verification report.

98. The method of claim 97 further comprising transmitting said verification report.

99. The method of claim 98 wherein said transmitting comprises transmitting said report to an entity in response to a request from said entity for verification of the identity.

100. The method of claim 98 wherein said transmitting comprises transmitting via an electronic communication network.

101. The method of claim 50 further comprising:
providing a certifier; and,
in the presence of said certifier, receiving said second biometric information from an individual.

102. The method of claim 50 further comprising:
providing a certifier; and, in the presence of said certifier, receiving identification information from an individual.

103. The method of claim 50 further comprising:
providing a certifier; and, certifying that an individual provided identification information to a certifier.

104. A system for registering biometric information, said system comprising:
a sensor configured to receive biometric information from an individual and communicate said biometric information to a processor; and
data input apparatus including at least one access device, said data input apparatus configured to receive identification information from said individual and certifying information from a certifier; wherein said certifying information certifies that said identification information was presented by said individual.

105. The system of claim 104 wherein said biometric information comprises a digitized template.

106. The system of claim 105 wherein said digitized template comprises a minutia template.

107. The system of claim 105 wherein said digitized template is in conformance with a standard.

108. The system of claim 107 wherein said standard is a CBEFF standard.

109. The system of claim 105 wherein said digitized template comprises a voice print.

110. The system of claim 105 wherein said digitized template comprises a face print.

111. The system of claim 105 wherein said digitized template comprises an iris scan.

112. The system of claim 105 wherein said digitized template comprises a retina scan.

113. The system of claim 105 wherein said digitized template comprises a hand scan.

114. The system of claim 104 wherein said data input apparatus is further configured to prompt said individual to provide said biometric information.

115. The system of claim 104 wherein said biometric information comprises a signal from a portion of said individual.

116. The system of claim 115 wherein said signal comprises an image.

117. The system of claim 115 wherein said signal comprises light.

118. The system of claim 115 wherein said signal comprises electrical charge.

119. The system of claim 115 wherein said signal comprises sound.

120. The system of claim 115 wherein said signal comprises pressure.

121. The system of claim 115 wherein said portion comprises at least a portion of a finger.

122. The system of claim 115 wherein said portion comprises at least a portion of a hand.

123. The system of claim 115 wherein said signal is transmitted from said hand to said device via an instrument.

124. The system of claim 123 wherein said instrument is a stylus.

125. The system of claim 123 wherein said instrument is a writing instrument.

126. The system of claim 115 wherein said portion comprises at least a portion of a mouth.

127. The system of claim 115 wherein said portion comprises at least a portion of an eye.

128. The system of claim 115 wherein said portion comprises at least a portion of an iris.

129. The system of claim 115 wherein said portion comprises at least a portion of a retina.

130. The system of claim 115 wherein said portion comprises at least a portion of a face.

131. The method of claim 113 wherein said portion comprises at least a portion of a blood vessel.

132. The system of claim 104 further comprising said processor; wherein said processor is configured to:
receive said biometric information;
receive said identification information; and
communicate to an entity a verification of an identity of said participant.

133. The system of claim 104 further comprising a certifier to certify that said biometric information is from said individual.

134. The system of claim 104 further comprising a certifier for certifying that said identification information is from said individual.

135. The system of claim 104 further comprising:
said processor; and
said certifier; wherein said processor is configured to:
receive first certifier biometric information from said certifier; and
compare said first certifier biometric information to second biometric information.

136. The system of claim 104 further comprising said certifier; wherein said certifier is a notary public.

137. The system of claim 104 wherein said data input apparatus is configured to receive an electronic notarization of a document.

138. A system for verifying the identity of a participant in an electronic transaction, said system comprising:
a processor configured to:
receive over an electronic communication network first physical biometric information received from said participant; and
compare said first physical biometric information to second biometric information; and
a data storage device configured to provide said second biometric information to said processor.

139. The system of claim 138 wherein said first physical biometric information comprises a first digitized template.

140. The system of claim 139 wherein said digitized template comprises a minutia template.

141. The system of claim 139 wherein said digitized template is in conformance with a standard.

142. The system of claim 141 wherein said standard is a CBEFF standard.

143. The system of claim 139 wherein said digitized template comprises a voice print.

144. The system of claim 139 wherein said digitized template comprises a face print.

145. The system of claim 139 wherein said digitized template comprises an iris scan.

146. The system of claim 139 wherein said digitized template comprises a retina scan.

147. The system of claim 139 wherein said digitized template comprises a hand scan.

148. The system of claim 138 wherein said second biometric information comprises a second digitized template.

149. The system of claim 148 wherein said digitized template comprises a minutia template.

150. The system of claim 148 wherein said digitized template is in conformance with a standard.

151. The system of claim 150 wherein said standard is a CBEFF standard.

152. The system of claim 148 wherein said digitized template comprises a voice print.

153. The system of claim 148 wherein said digitized template comprises a face print.

154. The system of claim 148 wherein said digitized template comprises an iris scan.

155. The system of claim 148 wherein said digitized template comprises a retina scan.

156. The system of claim 148 wherein said digitized template comprises a hand scan.

157. The system of claim 138 further comprising a sensor configured to receive said first physical biometric information and provide said first physical biometric information to said processor.

158. The system of claim 157 wherein said first physical biometric information comprises a signal from a portion of said participant.

159. The system of claim 158 wherein said signal comprises an image.

160. The system of claim 158 wherein said signal comprises light.

161. The system of claim 158 wherein said signal comprises electrical charge.

162. The system of claim 158 wherein said signal comprises sound.

163. The system of claim 158 wherein said signal comprises pressure.

164. The system of claim 158 wherein said portion comprises at least a portion of a finger.

165. The system of claim 158 wherein said portion comprises at least a portion of a hand.

166. The system of claim 158 wherein said portion comprises at least a portion of a mouth.

167. The system of claim 158 wherein said portion comprises at least a portion of an eye.

168. The system of claim 158 wherein said portion comprises at least a portion of an iris.

169. The system of claim 158 wherein said portion comprises at least a portion of a retina.

170. The system of claim 158 wherein said portion comprises at least a portion of a face.

171. The system of claim 158 wherein said portion comprises at least a portion of a blood vessel.

172. The system of claim 138 wherein said processor is further configured to identify a difference between a first digitized template and a second digitized template.

173. The system of claim 138 wherein said processor is further configured to identify a similarity between a first digitized template and a second digitized template.

174. The system of claim 138 wherein said processor is further configured to perform a statistical test using a first digitized templated and a second digitized template.

175. The system of claim 138 wherein said processor is further configured to provide a verification report.
